(19) United States
(12) Patent Application Publication
(10) Pub. No.: US 2025/0108710 A1
(43) Pub. Date: Apr. 3, 2025

(54) TECHNIQUES FOR INTEGRATING AND MANAGING FUEL CELL SYSTEMS IN FUEL CELL BATTERY ELECTRIC VEHICLES

(71) Applicant: FCA US LLC, Auburn Hills, MI (US)

(72) Inventors: Abhilash Gudapati, Troy, MI (US); Rudolf Kharpuri, Auburn Hills, MI (US); Raviteja Chanumolu, Hyderabad (IN); Omkar Bedarkar, Windsor (CA)

(21) Appl. No.: 18/479,355

(22) Filed: Oct. 2, 2023

(51) Int. Cl. B60L 50/75; B60L 3/00; B60L 3/12

(52) U.S. Cl. CPC B60L 50/75; B60L 3/0046; B60L 3/12; B60L 2240/547

(57) ABSTRACT

A synchronous high voltage control system for a fuel cell battery electric vehicle (FCBEV) includes a fuel cell propulsion system (FCPS) configured to control a fuel cell system of an electrified powertrain of the FCBEV based on a mode control signal, wherein FCPS is configured to control the fuel cell to selectively support a high voltage bus, and an electrified vehicle control unit (EVCU) configured to (i) supervise a battery pack control module (BPCM) that is configured to control contactors to connect or disconnect a high voltage battery system to and from the high voltage bus and (ii) generate the mode control signal for the FCPS, wherein the EVCU is configured to utilize the mode control signal to have synchronous behavior across all high voltage systems of the FCBEV including the high voltage battery system and the fuel cell system.

### FIELD

The present application generally relates to fuel cell battery electric vehicles (FCBEVs) and, more particularly, to techniques for integrating and managing fuel cell systems in FCBEVs.

### BACKGROUND

Electrified vehicles (EVs) have electrified powertrains including electric motor(s) powered by an electrical power system, such as a battery system. Some electrified powertrains further include an internal combustion engine for additional power generation, at the expense of emissions generated by the burning of a mixture of air and fuel (e.g., gasoline). One newer type of electrified vehicle is a fuel cell battery electric vehicle (FCBEV), which includes a fuel source (e.g., hydrogen) that is stored and selectively converted to electrical power, by a fuel cell system, for a high voltage battery system. As this is a newer technology, conventional (“off-the-shelf”) fuel cell propulsion controllers are designed to function independently from other high voltage related systems and thus are difficult to implement in existing controller area network (CAN) architectures, typically requiring complex/costly hardware and/or software changes. Accordingly, while such conventional FCBEVs do work well for their intended purpose, there exists an opportunity for improvement in the relevant art.

### SUMMARY

According to one example aspect of the invention, a synchronous high voltage control system for a fuel cell battery electric vehicle (FCBEV) is presented. In one exemplary implementation, the control system comprises a fuel cell propulsion system (FCPS) configured to control a fuel cell system of an electrified powertrain of the FCBEV based on a mode control signal, wherein the fuel cell system is controlled by the FCPS such that it converts a fuel source to electrical energy to selectively support a high voltage bus of the electrified powertrain, and an electrified vehicle control unit (EVCU) configured to (i) supervise a battery pack control module (BPCM) that is configured to control contactors to connect or disconnect a high voltage battery system to and from the high voltage bus and (ii) generate the mode control signal for the FCPS, wherein the EVCU is configured to utilize the mode control signal to have synchronous behavior across all high voltage systems of the FCBEV including the high voltage battery system and the fuel cell system.

In some implementations, the FCPS is not configured to supervise the BPCM. In some implementations, the FCPS is a standard off-the-shelf component and no additional hardware is required. In some implementations, the mode control signal indicates one of five different modes. In some implementations, the five different modes include an FCPS enable mode during which the fuel cell system supports the high voltage bus, an FCPS disable mode during which the fuel cell system does not support the high voltage bus, and three different fault shutdown modes. In some implementations, the FCPS enable and disable mode are based on (i) a propulsion system active (PSA) status indicative of whether a start-up procedure of the electrified powertrain is complete and (ii) a drive ready (DR) status indicative of whether the FCBEV is ready to drive.

In some implementations, one of the three different fault shutdown modes is a fault normal shutdown mode where the electrified powertrain's propulsion is disabled by the EVCU in response to a fault and the FCPS supports the high voltage bus and completes a set of remaining activities until the end of a normal shutdown period. In some implementations, one of the three different fault shutdown modes is a fault immediate shutdown mode where the electrified powertrain's propulsion is disabled by the EVCU in response to a fault and the FCPS supports the high voltage bus and completes a set of remaining activities until the end of a shortened shutdown period. In some implementations, one of the three different fault shutdown modes is a fault quick stop mode where the electrified powertrain's propulsion is disabled by the EVCU in response to a critical event and the FCPS supports the high voltage bus and completes a set of critical activities until the end of a quick shutdown period.

In some implementations, the three different fault shutdown modes include: (i) a fault normal shutdown mode where the electrified powertrain's propulsion is disabled by the EVCU in response to a first fault and the FCPS supports the high voltage bus and completes a first set of remaining activities until the end of a normal shutdown period, (ii) a fault immediate shutdown mode where the electrified powertrain's propulsion is disabled by the EVCU in response to a second fault and the FCPS supports the high voltage bus and completes a second set of remaining activities that is less than the first set of remaining activities until the end of a shortened shutdown period that is less than the normal shutdown period, and (iii) a fault quick stop mode where the electrified powertrain's propulsion is disabled by the EVCU in response to a critical event and the FCPS supports the high voltage bus and completes a set of critical activities that is less than the second set of remaining activities until the end of a quick shutdown period that is less than the shortened shutdown period.

According to another example aspect of the invention, a synchronous high voltage control method for an FCBEV is presented. In one exemplary implementation, the method comprises providing an FCPS, controlling, by the FCPS, a fuel cell system of an electrified powertrain of the FCBEV based on a mode control signal such that the fuel system converts a fuel source to electrical energy to selectively support a high voltage bus of the electrified powertrain, providing an EVCU configured to supervise a BPCM, controlling, by the EVCU, the BPCM to control contactors to connect or disconnect a high voltage battery system to and from the high voltage bus, and generating, by the EVCU, the mode control signal for the FCPS, wherein the EVCU is configured to utilize the mode control signal to have synchronous behavior across all high voltage systems of the FCBEV including the high voltage battery system and the fuel cell system.

In some implementations, the FCPS is not configured to supervise the BPCM. In some implementations, the FCPS is a standard off-the-shelf component and no additional hardware is required. In some implementations, the mode control signal indicates one of five different modes. In some implementations, the five different modes include an FCPS enable mode during which the fuel cell system supports the high voltage bus, an FCPS disable mode during which the fuel cell system does not support the high voltage bus, and three different fault shutdown modes. In some implementations, the FCPS enable and disable mode are based on (i) a propulsion system active (PSA) status indicative of whether a start-up procedure of the electrified powertrain is complete and (ii) a drive ready (DR) status indicative of whether the FCBEV is ready to drive.

In some implementations, one of the three different fault shutdown modes is a fault normal shutdown mode where the electrified powertrain's propulsion is disabled by the EVCU in response to a fault and the FCPS supports the high voltage bus and completes a set of remaining activities until the end of a normal shutdown period. In some implementations, one of the three different fault shutdown modes is a fault immediate shutdown mode where the electrified powertrain's propulsion is disabled by the EVCU in response to a fault and the FCPS supports the high voltage bus and completes a set of remaining activities until the end of a shortened shutdown period. In some implementations, one of the three different fault shutdown modes is a fault quick stop mode where the electrified powertrain's propulsion is disabled by the EVCU in response to a critical event and the FCPS supports the high voltage bus and completes a set of critical activities until the end of a quick shutdown period.

In some implementations, the three different fault shutdown modes include: (i) a fault normal shutdown mode where the electrified powertrain's propulsion is disabled by the EVCU in response to a first fault and the FCPS supports the high voltage bus and completes a first set of remaining activities until the end of a normal shutdown period, (ii) a fault immediate shutdown mode where the electrified powertrain's propulsion is disabled by the EVCU in response to a second fault and the FCPS supports the high voltage bus and completes a second set of remaining activities that is less than the first set of remaining activities until the end of a shortened shutdown period that is less than the normal shutdown period, and (iii) a fault quick stop mode where the electrified powertrain's propulsion is disabled by the EVCU in response to a critical event and the FCPS supports the high voltage bus and completes a set of critical activities that is less than the second set of remaining activities until the end of a quick shutdown period that is less than the shortened shutdown period.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a fuel cell electrified vehicle (FCBEV) having an example control system according to the principles of the present application;

FIG. 2 is a functional block diagram of an example control architecture for a control system of an FCBEV according to the principles of the present application; and

FIG. 3 is flow diagram of an example fuel cell integration and management system for a FCBEV according to the principles of the present application.

### DESCRIPTION

As previously discussed, a conventional (“off-the-shelf”) fuel cell propulsion system (“FCPS”) or controller for a fuel cell battery electric vehicle (FCBEV) is designed to operate independently from other high voltage related systems and thus are difficult to implement into existing controller area network (CAN) architectures, typically requiring hardware and/or software changes thereby increasing complexity and costs. In some fuel cell electrified vehicles (FCEVs), the FCPS is configured to supervise a battery pack control module (BPCM) and thus integration and management of high voltage operation (e.g., battery pack contactor control) is handled by the FCPS. In other FCEVs, such as FCBEVs where the high voltage battery pack or system is no longer part of the fuel cell network (supervised by the FCPS), there could be conflicting control or a lack of coordinated management of the high voltage components as an electrified vehicle control unit (EVCU) is configured to supervise the BPCM and other high voltage related systems other than the fuel cell system. This conflicting control or lack of synchronous behavior could potentially result in damage to the high voltage bus. In addition, a fuel cell system may continue running/operating for an extended period (e.g., 15 minutes) after a normal vehicle power-down to improve or maximize the longevity or life of the fuel cell system (e.g., conditioning the fuel cell system to avoid air/water therein from freezing).

Accordingly, techniques for improved integration and management (e.g., faster shutdown techniques) of fuel cell systems in FCBEVs are presented herein. As mentioned above, in certain FCEVs such as FCBEVs, there could be a lack of coordinated management (i.e., a lack of “synchronous control”) of the high voltage components of the FCBEV because the EVCU (and not the FCPS) is configured to supervise the BPCM and other high voltage related systems. The techniques presented herein are a unique system or sub-system outside of the current coordinated propulsion systems (the electrified powertrain) by modifying existing strategies to create a new interface to ensure that the FCPS correctly provides power to the high voltage bus when desired/necessary and without potentially causing damage. The EVCU determines when the FCPS starts and stops supporting the high voltage bus to have synchronous control or behavior across all of the high voltage systems. This is achieved via a mode control signal generated by the EVCU and transmitted to the FCPS via a CAN. The mode control signal specifies one of five different modes in which the FCPS is to operate according to the principles of the present application.

The five modes include two simple or basic modes-FCPS enabled and FCPS disabled. One of these modes is specified by the EVCU based on two other statuses: (1) a propulsion system active (PSA) status indicative of whether a start-up procedure of the electrified powertrain is complete and (ii) a drive ready (DR) status indicative of whether the FCBEV is ready to drive. When both are true, the FCPS is enabled (e.g., FCPS-enabled mode). Otherwise, the FCPS is disabled (e.g., FCPS-disabled mode). There are also three different fault shutdown modes. In a fault normal shutdown mode, the electrified powertrain's propulsion is disabled by the EVCU in response to a fault and the FCPS supports the high voltage bus and completes a first set of remaining activities until the end of a normal shutdown period. In a fault immediate shutdown mode, the electrified powertrain's propulsion is disabled by the EVCU in response to a fault and the FCPS supports the high voltage bus and completes a smaller second set of remaining activities until the end of a shortened shutdown period. In a fault quick stop mode, the electrified powertrain's propulsion is disabled in response to a critical event (e.g., a crash) or an open contactor event (e.g., contactor(s) on a high voltage bus opening and thereby disconnecting/disabling high voltage operation), and the FCPS supports the high voltage bus and completes an even smaller set of critical activities until the end of an even shorter quick shutdown period.

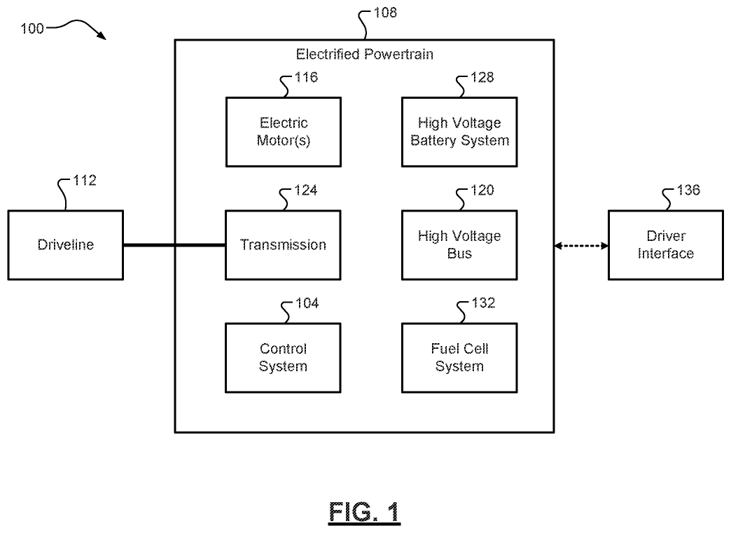

Referring now to FIG. 1, a functional block diagram of an FCBEV 100 having an example control system 104 according to the principles of the present application is illustrated. The FCBEV 100 (also referred to as “vehicle 100”) includes an electrified powertrain (ePT) 108 configured to generate and transfer torque to a driveline 112 for vehicle propulsion. The electrified powertrain 108 includes one or more electric motors 116 powered by a high voltage bus 120 and configured to generate drive torque (e.g., to satisfy a driver torque request via a driver interface 136) that is selectively transferred to the driveline 112 via a transmission 124. The high voltage bus 120 is supported or supplied with electrical current to maintain a high voltage level from a high voltage battery system 128 and/or a fuel cell system 132, which stores and converts a fuel source (e.g., hydrogen, or H2) to electrical energy. It will be appreciated that the FCBEV 100 could include other components, such as a low voltage (e.g., 12 volt) battery system, and other non-illustrated components, such as actuator(s), sensor(s), and/or other human input/output device(s). The control system 104 controls the operation of the FCBEV 100, including specific power up/down or start/shutdown processes, and is described in greater detail below.

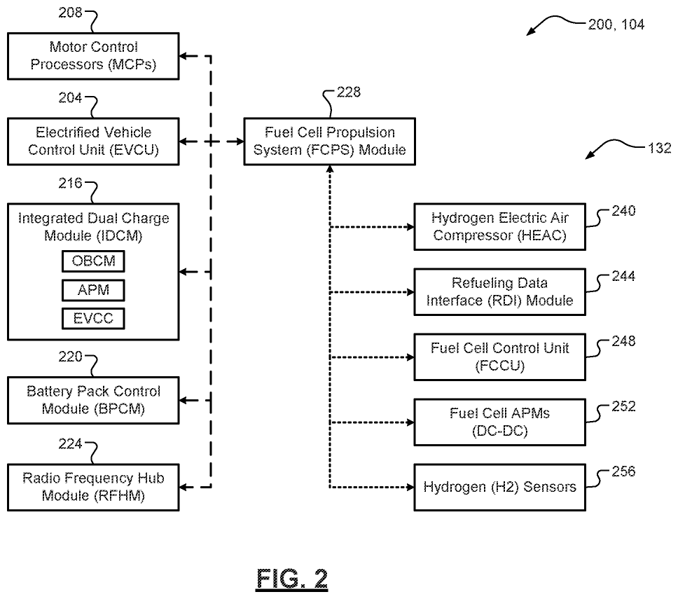

Referring now to FIG. 2, a functional block diagram of an example control architecture 200 for the control system 104 of the FCBEV 100 (see FIG. 1) according to the principles of the present application is illustrated. While the control architecture 200 is described with respect to control system 104 of FCBEV 100, it will be appreciated that the control architecture 200 could be applicable to any other suitable FCBEV/control system configurations. The control system 104 includes an electrified vehicle control unit (EVCU) 204 configured to control a set of primary operations of the FCBEV 100 (e.g., including vehicle actuators (not shown), such as pumps/valves) and one or more motor control processors (MCPs) 208 configured to control the electric motor(s) 116 (e.g., a front-end MCP 208 associated with a front axle and one electric motor 116 and a rear-end MCP 208 associated with a rear axle and another electric motor 116). The control system 104 also includes an integrated dual charging module (IDCM) 216 configured to control charging/recharging of the FCBEV 100 and, more particularly, the high voltage battery system 128. Non-limiting example components of the IDCM 216 include an on-board charging module (OBCM), an auxiliary power module (APM) (e.g., a DC-DC converter), and an electrified vehicle charge controller (EVCC).

The control system 104 further includes other modules, such as a BPCM 220 configured to control the high voltage battery system 128 and a radio frequency hub module (RFHM) 224 configured to communicate with other electronic modules either over the CAN or another communication channel to support certain vehicle features/systems (e.g., key fob presence detection). The EVCU 204 is configured for communication with each of the above-described modules/units via one or more CAN buses. It will be appreciated that the control system 104 could also include many other modules or components that are not illustrated for simplicity and because they are not particularly relevant to the techniques of the present application. Non-limiting examples of these other modules or components include a body control module (BCM), an electronic climate control (ECC) unit, an instrument panel cluster (IPC), a security gateway (SGW) module, diagnostic port(s), telematics module(s), an electronic steering lock (ESL) unit, an electronic shifter module (ESM), a driver assistance systems module (DASM), an electric power steering (EPS) unit, a brake system module (BSM), and an occupant restraint controller (ORC).

The control system 104 also includes an FCPS module 228 configured for communication with the EVCU 204 via one or more of the CAN buses. Unlike other FCEVs, the FCPS module 228 is not configured to supervise the BPCM 220. In one exemplary implementation, the FCPS module 228 is a standard off-the-shelf component and no additional hardware is required. The FCPS module 228 is configured to control modules/units of the fuel cell system 132, including, but not limited to, a hydrogen electric air compressor (HEAC) 240, a refueling data interface (RDI) module 244, a fuel cell control unit 248, one or more fuel cell APMs 252 (e.g., DC-DC converters), and H2 sensors 256. As previously mentioned, the EVCU 204 is configured to generate a mode control signal that is transmitted and utilized by the FCPS module 228 to control the fuel cell system 132 accordingly (e.g., to selectively support the high voltage bus 120). In other words, the EVCU 204 is configured to utilize the mode control signal to have synchronous behavior across all high voltage systems of the FCBEV 100 including the high voltage battery system 128 and the fuel cell system 132.

In one exemplary implementation, the mode control signal generated by the EVCU 204 and received/utilized by the FCPS module 228 indicates one of five different modes. The five different modes include, for example, (1) an FCPS enable mode during which the fuel cell system 132 supports the high voltage bus 120, (2) an FCPS disable mode during which the fuel cell system 132 does not support the high voltage bus 120, and three different fault shutdown modes. In one exemplary implementation, the FCPS enable and disable mode are based on (i) a PSA status indicative of whether a start-up procedure of the electrified powertrain 108 is complete (e.g., the RFHM 224 indicates cranking complete) and (ii) a drive ready (DR) status indicative of whether the FCBEV 100 is ready to drive. The PSA status could be active, for example, when all of the following conditions are true: (i) high voltage contactor(s) closed, (ii) vehicle immobilizer check passed, (iii) electric motor system(s) are active, (iv) EVCU shutoff path test passed, (v) high voltage interlock loop (HVIL) test passed, (vi) electric motor system low voltage and high voltage shutoff path tests passed, (vii) internal remedial action does not send a fault shutdown, and (viii) the high voltage bus is above a calibratable high voltage (e.g., 200 volts, based on the high voltage component capability).

The DR status could be active, for example, when all of the following conditions are true: (i) ignition in a post-start state and all propulsion systems are functioning as intended, (ii) electrified vehicle supply equipment (EVSE) is not plugged in, (iii) remote start is not enabled/active, and (iv) key-on ignition is true (e.g., the customer/driver pressed an ignition/start button). One of the three different fault shutdown modes is (3) a fault normal shutdown mode where the electrified powertrain's propulsion is disabled by the EVCU 204 in response to a fault and the FCPS 228 supports the high voltage bus 120 and completes a set of remaining activities until the end of a normal shutdown period. Another one of the three different fault shutdown modes is (4) a fault immediate shutdown mode where the electrified powertrain's propulsion is disabled by the EVCU 204 in response to a fault and the FCPS supports 228 the high voltage bus 120 and completes a smaller set of remaining activities until the end of a shortened shutdown period. Yet another one of the three different fault shutdown modes is (5) a fault quick stop mode where the electrified powertrain's propulsion is disabled by the EVCU 204 in response to a critical event and the FCPS 228 supports the high voltage bus and completes a set of critical activities until the end of a quick shutdown period.

In one exemplary implementation, the three different fault shutdown modes include (i) the fault normal shutdown mode where the electrified powertrain's propulsion is disabled by the EVCU 204 in response to a first fault and the FCPS 228 supports the high voltage bus 120 and completes the first set of remaining activities until the end of the normal shutdown period, (ii) the fault immediate shutdown mode where the electrified powertrain's propulsion is disabled by the EVCU 204 in response to a second fault and the FCPS 228 supports the high voltage bus 120 and completes the second set of remaining activities that is less than the first set of remaining activities until the end of the shortened shutdown period that is less than the normal shutdown period, and (iii) a fault quick stop mode where the electrified powertrain's propulsion is disabled by the EVCU 204 in response to a critical event and the FCPS 228 supports the high voltage bus 120 and completes the set of critical activities that is less than the second set of remaining activities until the end of the quick shutdown period that is less than the shortened shutdown period.

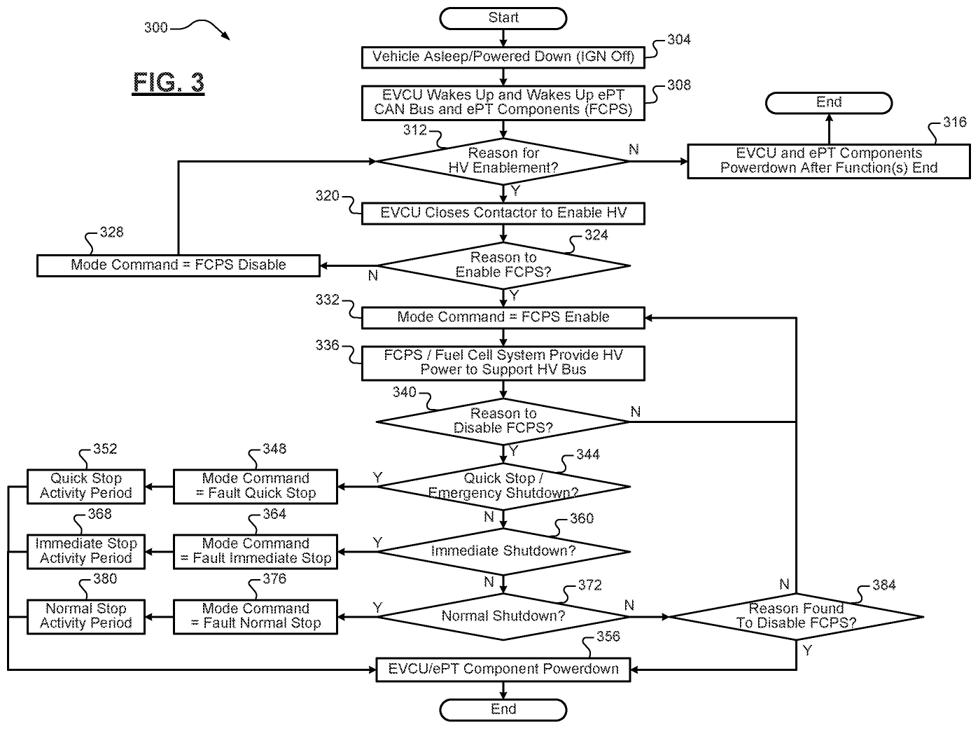

Referring now to FIG. 3, a flow diagram of a first example primary and secondary controller management method 300 for a control system 104 of an FCBEV 100 according to the principles of the present application is illustrated. While the method 300 is described with respect to the FCBEV 100 (also referred to as “vehicle 100”) and its control system 104 for illustrative and descriptive purposes, it will be appreciated that the method 300 could be applicable to any suitable FCBEV and control system. At 304, the vehicle 100 is asleep and its systems are powered down (e.g., in an ignition off state, with the CAN being inactive and powered down). At 308, the EVCU 204 wakes up and wakes up the electrified powertrain (ePT) bus and components of the electrified powertrain 108 including the FCPS 228. At 312, the EVCU 204 determines whether there is a reason for high voltage enablement. When false, the method 300 proceeds to 316 where the EVCU 204 and the ePT components (e.g., the FCPS 228) power down after functions end/complete and the method 300 ends or returns to 304. When true, the method 300 proceeds to 320 where the EVCU 204 requests for the contactor (between the high voltage bus 120 and the high voltage battery system 128) to close to enable high voltage.

At 324, the EVCU 204 determines whether there is a reason to enable the FCPS 228. When false, the method 300 proceeds to 328 where the EVCU 204 generates the mode control signal for the FCPS 228 to be disabled and the method 300 then returns to 316. When true, the method 300 proceeds to 332 where the EVCU 204 generates the mode control signal for the FCPS 228 to be enabled. At 336, the FCPS 228 controls the fuel cell system 132 to supply power to (support) the high voltage bus 120. At 340, the EVCU 204 determines whether there is a reason to disable the FCPS 228. When false, the method 300 returns to 332. When true, the method 300 proceeds to 344. At 344, the EVCU 204 determines whether there are any critical/emergency malfunctions or faults that require an emergency/quick high voltage system shutdown. When false, the method 300 proceeds to 360. When true, the method 300 proceeds to 348 where the EVCU 204 generates the mode control signal for a quick stop or emergency shutdown of the FCPS 228, then to 352 where the FCPS 228 completes its set of remaining critical activities within a quick stop or emergency period (e.g., ˜2 seconds), and then finally to 356 where the EVCU 204 and the ePT 108 components power-down based on an existing power-moding method/technique and the method 300 ends.

At 360, the EVCU 204 determines whether there are any critical malfunctions or faults that require an immediate high voltage system shutdown. When false, the method 300 proceeds to 372. When true, the method 300 proceeds to 364 where the EVCU 204 generates the mode control signal for an immediate shutdown of the FCPS 228, then to 368 where the FCPS 228 completes its set of remaining critical activities within an immediate shutdown period (e.g., ˜2 minutes), and then finally to 356 where the EVCU 204 and the ePT 108 components power-down based on an existing power-moding method/technique and the method 300 ends. At 372, the EVCU 204 determines whether there are any malfunctions or faults that require a normal high voltage system shutdown. When false, the method 300 proceeds to 384. When true, the method 300 proceeds to 376 where the EVCU 204 generates the mode control signal for a normal shutdown of the FCPS 228, then to 380 where the FCPS 228 completes its set of remaining activities within normal shutdown period (e.g., ˜10 minutes), and then finally to 356 where the EVCU 204 and the ePT 108 components power-down based on an existing power-moding method/technique and the method 300 ends. At 384, the EVCU 204 determines whether another reason was determined for the high voltage system shutdown. When false, the method 300 returns to 332 (i.e., no reason determined). When true, the method 300 proceeds to 356 where the EVCU 204 and the ePT 108 components power-down based on an existing power-moding method/technique and the method 300 ends.

It will be appreciated that the term “controller” as used herein refers to any suitable control device or set of multiple control devices that is/are configured to perform at least a portion of the techniques of the present application. It will also be appreciated that the terms “unit,” “module,” and “processor” could also be substituted for or also refer to other “controllers.” Some non-limiting examples of a “controller” include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A synchronous high voltage control system for a fuel cell battery electric vehicle (FCBEV), the control system comprising:
a fuel cell propulsion system (FCPS) configured to control a fuel cell system of an electrified powertrain of the FCBEV based on a mode control signal, wherein the fuel cell system is controlled by the FCPS such that it converts a fuel source to electrical energy to selectively support a high voltage bus of the electrified powertrain; and
an electrified vehicle control unit (EVCU) configured to (i) supervise a battery pack control module (BPCM) that is configured to control contactors to connect or disconnect a high voltage battery system to and from the high voltage bus and (ii) generate the mode control signal for the FCPS,
wherein the EVCU is configured to utilize the mode control signal to have synchronous behavior across all high voltage systems of the FCBEV including the high voltage battery system and the fuel cell system.

2. The control system of claim 1, wherein the FCPS is not configured to supervise the BPCM.

3. The control system of claim 1, wherein the FCPS is a standard off-the-shelf component and no additional hardware is required.

4. The control system of claim 1, wherein the mode control signal indicates one of five different modes.

5. The control system of claim 4, wherein the five different modes include an FCPS enable mode during which the fuel cell system supports the high voltage bus, an FCPS disable mode during which the fuel cell system does not support the high voltage bus, and three different fault shutdown modes.

6. The control system of claim 5, wherein the FCPS enable and disable mode are based on (i) a propulsion system active (PSA) status indicative of whether a start-up procedure of the electrified powertrain is complete and (ii) a drive ready (DR) status indicative of whether the FCBEV is ready to drive.

7. The control system of claim 5, wherein one of the three different fault shutdown modes is a fault normal shutdown mode where the electrified powertrain's propulsion is disabled by the EVCU in response to a fault and the FCPS supports the high voltage bus and completes a set of remaining activities until the end of a normal shutdown period.

8. The control system of claim 5, wherein one of the three different fault shutdown modes is a fault immediate shutdown mode where the electrified powertrain's propulsion is disabled by the EVCU in response to a fault and the FCPS supports the high voltage bus and completes a set of remaining activities until the end of a shortened shutdown period.

9. The control system of claim 5, wherein one of the three different fault shutdown modes is a fault quick stop mode where the electrified powertrain's propulsion is disabled by the EVCU in response to a critical event and the FCPS supports the high voltage bus and completes a set of critical activities until the end of a quick shutdown period.

10. The control system of claim 6, wherein the three different fault shutdown modes include:
(i) a fault normal shutdown mode where the electrified powertrain's propulsion is disabled by the EVCU in response to a first fault and the FCPS supports the high voltage bus and completes a first set of remaining activities until the end of a normal shutdown period;
(ii) a fault immediate shutdown mode where the electrified powertrain's propulsion is disabled by the EVCU in response to a second fault and the FCPS supports the high voltage bus and completes a second set of remaining activities that is less than the first set of remaining activities until the end of a shortened shutdown period that is less than the normal shutdown period; and
(iii) a fault quick stop mode where the electrified powertrain's propulsion is disabled by the EVCU in response to a critical event and the FCPS supports the high voltage bus and completes a set of critical activities that is less than the second set of remaining activities until the end of a quick shutdown period that is less than the shortened shutdown period.

11. A synchronous high voltage control method for a fuel cell battery electric vehicle (FCBEV), the method comprising:
providing a fuel cell propulsion system (FCPS);
controlling, by the FCPS, a fuel cell system of an electrified powertrain of the FCBEV based on a mode control signal such that the fuel system converts a fuel source to electrical energy to selectively support a high voltage bus of the electrified powertrain;
providing an electrified vehicle control unit (EVCU) configured to supervise a battery pack control module (BPCM);
controlling, by the EVCU, the BPCM to control contactors to connect or disconnect a high voltage battery system to and from the high voltage bus; and
generating, by the EVCU, the mode control signal for the FCPS,
wherein the EVCU is configured to utilize the mode control signal to have synchronous behavior across all high voltage systems of the FCBEV including the high voltage battery system and the fuel cell system.

12. The method of claim 11, wherein the FCPS is not configured to supervise the BPCM.

13. The method of claim 11, wherein the FCPS is a standard off-the-shelf component and no additional hardware is required.

14. The method of claim 11, wherein the mode control signal indicates one of five different modes.

15. The method of claim 14, wherein the five different modes include an FCPS enable mode during which the fuel cell system supports the high voltage bus, an FCPS disable mode during which the fuel cell system does not support the high voltage bus, and three different fault shutdown modes.

16. The method of claim 15, wherein the FCPS enable and disable mode are based on (i) a propulsion system active (PSA) status indicative of whether a start-up procedure of the electrified powertrain is complete and (ii) a drive ready (DR) status indicative of whether the FCBEV is ready to drive.

17. The method of claim 15, wherein one of the three different fault shutdown modes is a fault normal shutdown mode where the electrified powertrain's propulsion is disabled by the EVCU in response to a fault and the FCPS supports the high voltage bus and completes a set of remaining activities until the end of a normal shutdown period.

18. The method of claim 15, wherein one of the three different fault shutdown modes is a fault immediate shutdown mode where the electrified powertrain's propulsion is disabled by the EVCU in response to a fault and the FCPS supports the high voltage bus and completes a set of remaining activities until the end of a shortened shutdown period.

19. The method of claim 15, wherein one of the three different fault shutdown modes is a fault quick stop mode where the electrified powertrain's propulsion is disabled by the EVCU in response to a critical event and the FCPS supports the high voltage bus and completes a set of critical activities until the end of a quick shutdown period.

20. The method of claim 16, wherein the three different fault shutdown modes include:
(i) a fault normal shutdown mode where the electrified powertrain's propulsion is disabled by the EVCU in response to a first fault and the FCPS supports the high voltage bus and completes a first set of remaining activities until the end of a normal shutdown period;
(ii) a fault immediate shutdown mode where the electrified powertrain's propulsion is disabled by the EVCU in response to a second fault and the FCPS supports the high voltage bus and completes a second set of remaining activities that is less than the first set of remaining activities until the end of a shortened shutdown period that is less than the normal shutdown period; and
(iii) a fault quick stop mode where the electrified powertrain's propulsion is disabled by the EVCU in response to a critical event and the FCPS supports the high voltage bus and completes a set of critical activities that is less than the second set of remaining activities until the end of a quick shutdown period that is less than the shortened shutdown period.
